(19) United States
(12) Patent Application Publication
(10) Pub. No.: US 2026/0317202 A1
(43) Pub. Date: Oct. 15, 2026

(54) Treatment Systems and Methods

(71) Applicant: Geosyntec Consultants, Inc., Boca Raton, FL (US)

(72) Inventors: Allison Kreinberg, Boca Raton, FL (US); Duane Graves, Boca Raton, FL (US)

(21) Appl. No.: 19/109,363

(22) PCT Filed: Sep. 13, 2023
(86) PCT No.: PCT/US2023/032640

§ 371 Date: Mar. 6, 2025

Related U.S. Application Data
(60) Provisional application No. 63/375,595, filed on Sep. 14, 2022.

(51) Int. Cl. C02F 1/28; C02F 1/52; C02F 1/66; C02F 101/10; C02F 101/20; C02F 103/06

(52) U.S. Cl. CPC C02F 1/286; C02F 1/5245; C02F 1/66; C02F 2101/108; C02F 2101/20; C02F 2103/06; C02F 2209/44

(57) ABSTRACT

Systems and methods for converting a nonionized form of an unwanted species in an influent of media having an initial concentration of the unwanted species to an anionic form of the unwanted species, exposing the anionic form of the unwanted species to a cationic form of a removal agent, and removing at least a portion of the unwanted species from the media via removal of at least a portion of the unwanted species ionically bonded to the removal agent, wherein after the removing, an effluent of the media has a treated concentration of the unwanted species less than the initial concentration.

### CROSS-REFERENCE TO RELATED APPLICATIONS

This application claims the benefit under 35 USC § 119(e), of U.S. Provisional Patent Application No. 63/375,595 filed 14 Sep. 2022, the entire contents and substance of being incorporated herein by reference in its entirety as if fully set forth below.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Disclosure

Embodiments of the present disclosure relate generally to treatment technologies, and more particularly to water treatment technologies for removal of boron and certain other water-soluble metals.

### 2. Background

Groundwater, surface water, and industrial wastewater may be contaminated with boron and certain other metals, such as molybdenum, that are difficult to remove from solution and that are either regulated at the state or federal level or are likely to be. These metals are often toxic above environment or organism specific threshold concentrations, such as general aquatic toxicity or toxicity to plants, animals and/or people.

In these cases, the metal is typically regulated for removal below a specified concentration before the water can be discharged to the environment or used for drinking or recreation. Technologies for removing boron from water include reverse osmosis, ion exchange media and chelating resins for above ground (ex situ) water treatment. These technologies are not suitable for application within an aquifer (in situ) for the in-place removal of boron from groundwater.

Boron is a metalloid that is found in nature, with the majority of the Earth's boron located in the ocean. Freshwater typically contains a small concentration of boron but the concentration can be significantly increased as a result of wastewater discharges or nearby industrial activity.

Boron exists in water as a free (uncharged) acid at a circumneutral pH and transitions to a borate oxyanion at an alkaline pH of approximately 9.2 and higher. A borate is any of a range of boron oxyanions, anions containing boron and oxygen, such as orthoborate BO₃⁻³, metaborate BO₂⁻¹, or tetraborate BO₄O₂⁻⁷; or any salt of such anions, such as sodium metaborate, Na⁻[BO₂]⁻ and borax (Na⁺)₂[B₄O₇]²⁻. The name also refers to esters of such anions, such as trimethyl borate B(OCH₃)₃, which in contrast to various borate salts, is a covalently bonded organic molecule that decomposes in water to form boric acid that is subject to treatment by the present technology.

Molybdenum does not occur naturally as a free metal on Earth; it is found only in various oxidation states in minerals. The refined free element, a silvery metal with a grey cast, has the sixth-highest melting point of any element. It readily forms hard, stable carbides in alloys, and for this reason most of the world production of the element (about 80%) is used in steel alloys, including high-strength alloys and superalloys.

Most molybdenum compounds have low solubility in water, but when molybdenum-bearing minerals contact oxygen and water, the resulting molybdate ion MoO₄²⁻ is quite soluble. Industrially, molybdenum compounds (about 14% of world production of the element) are used in high-pressure and high-temperature applications as pigments and catalysts.

For drinking water, the World Health Organization (WHO) recommends a guideline concentration of boron of 2.4 milligrams per liter (mg/L) in the Fourth Edition of their Guidelines for Drinking Water Quality published in 2022. Boron concentration limits below 2 mg/L are commonly set by regulatory bodies when discharging to natural waterways.

Tolerable upper intake levels (ULs) for molybdenum are 2000 μg/day based on recommendations from the National Institutes of Health.

Increased boron content causes problems in cardiovascular, coronary, nervous and reproductive systems. It is particularly unsafe for pregnant women to be exposed to excess boron because of the increased risk of birth pathology. Boron removal thus is essential as high boron concentrations can be toxic to humans, plants, and aquatic life.

One example of boron contamination occurs with coal combustion residuals (CCR) stored in impoundments at coal-fired power plants. Boron is a primary indicator of CCR impacts to groundwater due to its elevated concentration within CCR materials and highly mobile (conservative) geochemical behavior. Boron essentially moves at the same rate as groundwater with little to no interaction or retardation from the aquifer matrix (soil and rocks).

At the federal level boron is not recognized as a metal that requires remediation; there is no maximum contamination level (MCL) for boron in groundwater. However, boron is currently included as a detection monitoring constituent under the Federal CCR Rule (40 CFR 257 Subpart D) and is expected to be added to the list of assessment monitoring constituents in the near future based on a proposed rule released by USEPA in March 2018.

When concentrations of detection monitoring constituents exceed the site-specific groundwater protection standard (GWPS), the site must either complete an alternative source demonstration (ASD) or initiate a more comprehensive assessment monitoring program. A GWPS of 4.0 mg/L was proposed for boron in the 2018 proposed rule. If exceedances are identified for assessment monitoring constituents, the site must either complete an ASD or initiate corrective action.

While boron exceedances do not directly result in corrective action at CCR sites under the current Federal CCR rule, environmental non-governmental organizations (NGOs) are advocating for the inclusion of boron as an assessment monitoring constituent.

Additionally, as state CCR regulatory programs gain primacy over the Federal CCR Rule, these programs may include boron as an assessment monitoring criterion as has been done in Illinois. Illinois has published a CCR GWPS for boron of 2.0 mg/L (35 IAC 845.600). Other states (California, Florida, Maine, Minnesota, New Hampshire and Wisconsin) have drinking water standards or guidelines for boron which can range from 0.6 to 1 mg/L.

As boron becomes incorporated in Federal or state CCR assessment monitoring programs, exceedances will require corrective action to address groundwater impacts. The growing concern about boron in groundwater at coal fired powerplants arises because many CCR impoundments will leach boron at concentrations higher than the anticipated GWPS.

Another problematic metal is molybdenum which is also difficult to remove from groundwater and for which reliable treatment options are limited. Both boron and molybdenum in the form of molybdate migrate with groundwater with very little retardation, meaning that areas of contaminated groundwater can become extensive with no meaningful attenuation of concentration nor reduction of mass in solution.

Currently available remedies include reverse osmosis, chelating resins, and ion-exchange media. However, the effectiveness of these remedies has not been proven for CCR-impacted leachate or groundwater.

Additionally, these conventional remedies are cost-prohibitive due to the large volume of reactive media required to treat multi-million to billions of gallons of groundwater as compared to relatively small process water streams in industrial applications where they are generally intended to operate.

What is needed, therefore, are systems and methods that provide water treatment technologies for removal of boron and certain other water-soluble metals.

Simply stated, existing technologies are not suitable for in situ application, a problem which is overcome by the present invention since it is suitable for both in situ and ex situ applications.

### BRIEF SUMMARY OF THE DISCLOSURE

Embodiments of the present disclosure address these concerns as well as other needs that will become apparent upon reading the description below in conjunction with the drawings. Briefly described, embodiments of the present disclosure relate generally to a process that alters the chemistry of an unwanted species in a media, like boron in groundwater, such that it is converted from a free acid to negatively charged borate anions. As borate, the oxyanion will be attracted to, and ionically bond with, positively charged removal agents.

The unwanted species can be/also include other toxic, hazardous, or environmentally objectionable compositions, like molybdenum.

In an exemplary one step process of the present invention, an influent of media (for example, water) having an initial concentration (for example, an unsafe concentration) of an unwanted species (for example, boron) exceeding a treatment target level (TTL) is passed through a reaction zone comprising a first reagent and a second reagent, wherein after the reaction zone, an effluent of the media has a treated concentration (for example, a safe concentration) of the unwanted species less than the TTL.

As used herein, a TTL can differ among regulating bodies and among different treatment environments. For example, depending on the regulating entity (country, state, or industry), the TTL can include the aforementioned CCR GWPS, which is specific to groundwater (as the treatment environment). Additionally, the TTL can refer to an MCL for drinking water (as the treatment environment).

Those of ordinary skill in the art will appreciate that many different TTLs are currently known, or will be set in the future, and that the present invention is designed to remediate an influent having a concentration level of an unwanted species above a specific TTL using an innovative method/system, to produce an effluent having a concentration level of the unwanted species at or below the specific TTL.

In an exemplary two-step process of the present invention, in a first step, a nonionized form of the unwanted species like boron in an influent of media like water having an initial concentration of the unwanted species is converted to an anionic form of the unwanted species (in this example, the oxyanion borate).

In a second step, the anionic form of the unwanted species (borate) is exposed to a cationic form of a removal agent (for example, sawdust), to ionically bond the borate to the positively charged (insoluble material) sawdust.

Various exemplary embodiment of the present invention utilize different spatial and/or temporal aspects of the one or two-step process. For example, the first and second reagent can be co-located in/on an engineered permeable reactive barrier. In this example, the influent is introduced to the reagents at the same location and at the same time.

As media flows through the barrier, the (fixed amounts of reagents) are consumed by varying degrees based upon media/unwanted species characteristics. For example only, with a barrier having fixed amounts of first and second reagents, the reagents will be consumed at varying rates depending on, for example, the pH of the influent, and/or the flow rate of the influent, and/or other characteristics of one or more of the influent, the unwanted species, the first reagent, the second reagent, the filler, and the type of remediation (in situ or ex situ applications).

In another exemplary embodiment of the present invention, spatial aspects of the invention methods and systems can differ. For example, the media can be initially introduced to the first reagent, and then subsequently introduced to the second reagent. This can occur in situations where a zone of first reagent is upstream of a zone of second reagent. Or this can occur in situations where first reagent is introduced to the media (for example, via injection/mixing) prior to a subsequent introduction of the second reagent (for example, again via injection/mixing) that occurs after the first reagent was introduced.

An important feature of the present invention is what it does, not when or where it does it. And in an exemplary embodiment, what it does is raise the pH of an influent having an initial concentration of an unwanted species exceeding a TTL (converting a nonionized form of the unwanted species to an anionic form of the unwanted species) and exposing the anionic form of the unwanted species to a cationic form of a removal agent, and via ionic bonding, the unwanted species/removal agent is effectively removed in sufficient quantities to produce an effluent having a concentration of the unwanted species below the TTL.

As used herein, being “effectively removed” includes many different forms of inhibiting the unwanted species/removal agent from continuing downstream in the effluent. For example, in the engineered permeable reactive barrier embodiment, the influent flows through the barrier having both the first and second reagents, and the barrier concurrently actuates the inventive method of the present invention while “trapping” the unwanted species/second reagent at the same time/location. The flow rate of the influent/effluent can be tuned using a filler, for example.

Being “effectively removed” can also include filtering, fluidization, flotation, settling, and coagulation/flocculation of the unwanted species/second reagent-again being dependent on the use environment of the present invention.

In another exemplary embodiment of the present invention, a method comprises converting a nonionized form of an unwanted species in an influent of media having an initial concentration of the unwanted species to an anionic form of the unwanted species, exposing the anionic form of the unwanted species to a cationic form of a removal agent, and effectively removing at least a portion of the unwanted species (ionically bound to the removal agent) from the media, wherein after the effective removing, an effluent of the media has a treated concentration of the unwanted species less than the initial concentration, more preferably, less than a TTL.

In any of the embodiments, the converting can comprise exposing the influent to a barrier having a first amount of a first reagent. Over time, the first reagent will be spent as it is used to convert the nonionized form of the unwanted species to the anionic form of the unwanted species.

In any of the embodiments, the converting can comprise mixing a first amount of the first reagent with the influent. The first amount of first reagent can be introduced to the influent via injection or other means, and can be injected over time, or in a single step, as influent continues to flow through the zone where the first reagent is introduced to the influent.

In any of the embodiments, the exposing can comprise exposing the influent to a barrier having a second amount of a second reagent. Over time, the second reagent will be spent as it is used to bind to the anionic form of the unwanted species, and then effectively removed from the media.

In any of the embodiments, the exposing can comprise mixing a second amount of the second reagent with the media. The second amount of second reagent can be introduced to the media via injection or other means, and can be injected over time, or in a single step, as media with the anionic form of the unwanted species continues to flow through the zone where the second reagent is introduced to the media.

In any of the embodiments, the nonionized form of the unwanted species can be converted to the anionic form of the unwanted species through a reagent-controlled pH reaction with the first reagent.

In any of the embodiments, at least a portion of the converting can be concurrent with at least a portion of the exposing.

In any of the embodiments, the exposing can be fully subsequent the converting.

In any of the embodiments, the unwanted species can be from completely soluble in the media to partially soluble in the media. In any of the embodiments, the removal agent can be from completely insoluble in the media to partially insoluble in the media. As the present invention seeks to effectively remove the unwanted species from the media via effectively removing the unwanted species/second reagent (or removal agent) from continuing downstream in the effluent, it is most effective in this action when the unwanted species is more closely to completely soluble in the media (although this encompasses a range of solubilities in the “more closely”), and when the second reagent/removal agent is more closely to completely insoluble in the media (although this too encompasses a range of solubilities in the “more closely”).

In any of the embodiments, the initial concentration of the unwanted species can exceed a TTL.

In any of the embodiments, the treated concentration of the unwanted species can be less than the TTL.

In any of the embodiments, the unwanted species can be boron, molybdenum, and/or other toxic, hazardous, or environmentally objectionable compositions, the media can be water, and the removal agent can comprise organic material, including cellulosic material, such as sawdust.

In another exemplary embodiment of the present invention, a method comprises first exposing a nonionized form of an unwanted species in an influent of media having an initial concentration of the unwanted species to a first amount of a first reagent, and second exposing at least a portion of the anionic form of the unwanted species to a cationic form of a second amount of a second reagent, wherein after the second exposing, an effluent of the media has a treated concentration of the unwanted species less than the initial concentration.

In another exemplary embodiment of the present invention, a method comprises a first reaction to convert a nonionized form of an unwanted species to an anionic form of the unwanted species, and a second reaction to ionically bond at least a portion of the anionic form of the unwanted species to a cationic form of a removal agent, wherein if at least a portion of the unwanted species now bound to the removal agent is effectively removed, an effluent of the media would be left with a treated concentration of the unwanted species less than an initial concentration of the unwanted species in the influent. This can be a step of removal from solution of the unwanted species, which is ionically bonded to the second reagent, from the media.

In any of the embodiments, the method can further comprise the step of effectively removing or effectively eliminating at least a portion of the unwanted species, which is ionically bonded to the second reagent, from the media. In all real respects, effectively eliminating will not mean fully eliminating.

In any of the embodiments, the reaction zone can comprise an amount of filler, and a variance in the reaction time can be at least partially due to the amount of filler.

In any of the embodiments, the variance in the reaction time can also be at least partially due to characteristics of the filler selected from the group consisting of filler chemistry, filler particle size, and filler density.

In any of the embodiments, the first exposing can comprise converting the nonionized form of the unwanted species to the anionic form of the unwanted species through a reagent-controlled pH reaction with the first reagent.

In any of the embodiments, at least a portion of the first exposing can be concurrent with at least a portion of the second exposing.

In any of the embodiments, the second exposing can be fully subsequent to the first exposing.

In any of the embodiments, the unwanted species is soluble in the media.

In any of the embodiments, the second reagent/removal agent is insoluble in the media.

In any of the embodiments, the initial concentration of the unwanted species can exceed a TTL.

In any of the embodiments, the treated concentration of the unwanted species can be less than the TTL.

In any of the embodiments, the unwanted species can be boron, molybdenum, and/or other toxic, hazardous, or environmentally objectionable compositions, the media can be water, and the removal agent can comprise organic material, including cellulosic material, such as sawdust.

In any of the embodiments, the filler can be sand or other inert, solid, nonporous medium.

In another exemplary embodiment of the present invention, a method comprises the above-described one step process of passing an influent of media having an initial concentration of unwanted species exceeding a TTL through a reaction zone comprising a first reagent and a second reagent, wherein after the reaction zone, an effluent of the media has a treated concentration of the unwanted species less than the TTL.

In any of the embodiments, the method can further comprise controlling a residence time of the media in the reaction zone. In any of the embodiments, the reaction zone can further comprise a filler, the characteristics of which enable variance in the reaction time.

In another exemplary embodiment, the present invention is a method, process, or system configured to practice the method or process, wherein the method or process comprises converting a nonionized form of an unwanted species in an influent of media having an initial concentration of the unwanted species to an anionic form of the unwanted species, and exposing the anionic form of the unwanted species to a cationic form of a removal agent, wherein an effluent of the media has a treated concentration of the unwanted species less than the initial concentration.

In any of the embodiments, the method or process can further comprise inhibiting at least a portion of the unwanted species, which is ionically bonded to the removal agent, from the effluent.

In any of the embodiments, the initial concentration of the unwanted species preferably exceeds a treatment target level (TTL). The treated concentration of the unwanted species preferably is less than the TTL.

In any of the embodiments, the method or process can be an in situ method of process of remediation of the influent, wherein the converting, exposing and inhibiting occur in a reaction zone, and wherein the reaction zone is at least a portion of a construction selected from the group consisting of a trench, an excavation, a large diameter borehole, a funnel and gate permeable reactive barrier system, a horizontal reactive mat constructed over groundwater seep areas, a constructed wetland, other civil or environmental engineered systems designed to retain the reaction zone and allow the influent to pass therethrough, and a combination thereof.

In any of the embodiments, the method or process can be an ex situ method of process of remediation of the influent, influent, wherein the converting, exposing and inhibiting occur in a reaction zone, and wherein the reaction zone is at least a portion of a construction selected from the group consisting of a tank, a column, other above ground structures designed to retain the reaction zone and allow the influent to pass therethrough, and a combination thereof.

In any of the embodiments, the converting can comprise mixing a first amount of a first reagent with the influent. The exposing can comprise mixing a second amount of the removal agent.

In any of the embodiments, the nonionized form of the unwanted species can be converted to the anionic form of the unwanted species through a reagent-controlled pH reaction with the first reagent.

In any of the embodiments, at least a portion of the converting can be concurrent with at least a portion of the exposing. The exposing can be fully subsequent to the converting.

In any of the embodiments, the unwanted species can be at least partially soluble in the media. The removal agent can be at least partially insoluble in the media.

In any of the embodiments, the unwanted species can boron. The media can be an aqueous media. The removal agent can comprise organic material. The removal agent can be cellulosic material. The removal agent can be sawdust.

In another exemplary embodiment, the present invention is a method, process, or system configured to practice the method or process, wherein the method or process comprises converting a nonionized form of an unwanted species in an influent of media having an initial concentration of the unwanted species to an anionic form of the unwanted species, exposing the anionic form of the unwanted species to a cationic form of a removal agent, and inhibiting at least a portion of the unwanted species, which is ionically bonded to the removal agent, from an effluent of the media, wherein the effluent has a treated concentration of the unwanted species less than the initial concentration, and wherein a reaction efficiency of initial concentration/treated concentration is 8.4% of the influent concentration passes through uninhibited to the effluent.

In any of the embodiments, the reaction efficiency can be less than 3.9% of the initial concentration being uninhibited by the present invention and thus passing through in the effluent.

In another exemplary embodiment, the present invention is a method, process, or system configured to practice the method or process, wherein the method or process is configured for both in situ and ex situ processing of a contaminated influent of media comprising converting a nonionized form of a contaminate in the contaminated influent of a water media having an initial concentration of the contaminate to an anionic form of the contaminate, exposing the anionic form of the contaminate to a cationic form of a removal agent, and inhibiting at least a portion of the contaminate, which is ionically bonded to the removal agent, from an effluent of the water media, wherein the effluent has a treated concentration of the contaminate less than the initial concentration.

In any of the embodiments, the contaminate can be boron. The media can comprise water. The removal agent can comprises organic material, more preferably cellulosic material.

In any of the embodiments, the initial concentration of the contaminate preferably exceeds a TTL, and the treated concentration of the contaminate preferably is less than the TTL.

In any of the embodiments, the converting can comprise mixing a first amount of a first reagent with the boron-contaminated influent.

In any of the embodiments, the exposing can comprises mixing a second amount of the removal agent.

In any of the embodiments, the boron can be converted to borate through a reagent-controlled pH reaction with the first reagent.

In any of the embodiments, the converting, exposing and inhibiting can occur in a reaction zone at substantially the same time. The converting, exposing and inhibiting can each occur in the same reaction zone, but at discretely different times.

In another exemplary embodiment, the present invention is a method, process, or system configured to practice the method or process, wherein the method or process comprises converting a nonionized form of an unwanted species in an influent of media having an initial concentration of the unwanted species to an anionic form of the unwanted species, exposing the anionic form of the unwanted species to a cationic form of a removal agent, and effectively removing at least a portion of the unwanted species, which is ionically bonded to the removal agent, from an effluent of the media, wherein the effluent has a treated concentration of the unwanted species less than the initial concentration.

In any of the embodiments, the method can have an attainment standard (CQ1) of less than 1.6 when compared to a conventional/alternative technology used for the same purpose.

In any of the embodiments, the method can have a capacity of reagent (CQ2) of greater than 50%.

In any of the embodiments, the method can have a longevity of reagent (CQ3) of greater than 13%.

In any of the embodiments, the method can have a stability of reagent (CQ4) of less than 2.2.

In any of the embodiments, the method can have a relative rate of treatment (CQ5) of less than 19.

In any of the embodiments, the method can have an effluent quality based on weighted Boolean parameters (CQ6) of greater than 6.

In any of the embodiments, the method can have relative sustainability index (RSI) of over 4.3.

In another exemplary embodiment, the present invention is a method, process, or system configured to practice the method or process, wherein the method or process comprises converting a nonionized form of an unwanted species in an influent of media having an initial concentration of the unwanted species to an anionic form of the unwanted species, exposing the anionic form of the unwanted species to a cationic form of a removal agent, and inhibiting at least a portion of the unwanted species, which is ionically bonded to the removal agent, from an effluent of the media, wherein the converting, exposing and inhibiting occur in a reaction zone over a reaction time.

In any of the embodiments, the reaction zone can comprise filler material.

In any of the embodiments, a reaction efficiency of initial concentration/treated concentration can be less than 8.4% pass through when the influent comprises water at an influent pore volumes and the unwanted species is boron, the converting comprises mixing the influent with a first reagent selected from the group consisting of brucite (Mg(OH)₂, magnesium oxide (MgO) and crushed concrete to form borate, and the exposing comprises mixing the influent comprising borate with the removal agent comprising organic material.

In another exemplary embodiment, the present invention is a method, process, or system configured to practice the method or process, wherein the method or process comprises first exposing a nonionized form of an unwanted species in an influent of media having an initial concentration of the unwanted species to a first amount of a first reagent and second exposing at least a portion of the anionic form of the unwanted species to a cationic form of a second amount of a second reagent, wherein after the second exposing, an effluent of the media has a treated concentration of the unwanted species less than the initial concentration.

In another exemplary embodiment, the present invention is a method, process, or system configured to practice the method or process, wherein the method or process comprises first exposing an influent of groundwater having an initial concentration of boron to a first amount of a first reagent selected from the group consisting of brucite (Mg(OH)₂, magnesium oxide (MgO), and crushed concrete and second exposing at least a portion of borate formed during the first exposing to a second amount of a second reagent comprising organic material, wherein after the second exposing, an effluent of the groundwater has a treated concentration of boron less than the initial concentration.

In another exemplary embodiment, the present invention is a method, process, or system configured to practice the method or process, wherein the method or process comprises first exposing an influent of groundwater having an initial concentration of molybdenum to a first amount of a first reagent, and second exposing at least a portion of molybdate formed during the first exposing to a second amount of a second reagent, wherein after the second exposing, an effluent of the groundwater has a treated concentration of molybdenum less than the initial concentration.

In another exemplary embodiment, the present invention is a method, process, or system configured to practice the method or process, wherein the method or process comprises first exposing a nonionized form of an unwanted species in an influent of media having an initial concentration of the unwanted species to a first amount of a first reagent, second exposing at least a portion of the anionic form of the unwanted species to a cationic form of a second amount of a second reagent, and inhibiting at least a portion of the unwanted species, which is ionically bonded to the second reagent, from an effluent of the media, wherein after the second exposing, the effluent has a treated concentration of the unwanted species less than the initial concentration.

In any of the embodiments, the inhibiting can comprise separating at least a portion of the unwanted species, which is ionically bonded to the second reagent, from the media by a separating action selected from the group consisting of filtering, fluidization, flotation, settling, coagulation/flocculation, and a combination thereof.

In any of the embodiments, the first exposing and the second exposing can occur over a reaction time in a reaction zone and the inhibiting can be controllable with variance in the reaction time.

In any of the embodiments, the reaction zone can comprise filler, and variance in the reaction time can be at least partially due to the filler.

In any of the embodiments, variance in the reaction time can also be at least partially due to characteristics of the filler selected from the group consisting of filler chemistry, filler particle size, filler density, and a combination thereof.

In any of the embodiments, the first exposing can comprises converting the nonionized form of the unwanted species to the anionic form of the unwanted species through a reagent-controlled pH reaction with the first reagent.

In any of the embodiments, at least a portion of the first exposing can be concurrent with at least a portion of the second exposing.

In any of the embodiments, the second exposing can be fully subsequent the first exposing.

In any of the embodiments, the unwanted species can be soluble in the media.

In any of the embodiments, the second reagent can be insoluble in the media.

In any of the embodiments, the initial concentration of the unwanted species can exceed a TTL. In any of the embodiments, the treated concentration of the unwanted species can be less than the TTL.

In any of the embodiments, the unwanted species can be boron. In any of the embodiments, the media can comprise water. In any of the embodiments, the second reagent can comprise organic material. In any of the embodiments, the second reagent can be cellulosic material. In any of the embodiments, the second reagent can be sawdust. In any of the embodiments, the filler can be an inert, solid, nonporous medium. In any of the embodiments, the filler can be sand.

In another exemplary embodiment, the present invention is a method, process, or system configured to practice the method or process, wherein the method or process comprises passing an influent of media having an initial concentration of unwanted species exceeding a TTL through a reaction zone comprising a first reagent and a second reagent, wherein after the reaction zone, an effluent of the media has a treated concentration of the unwanted species less than the TTL.

In any of the embodiments, the method or process can further comprise controlling a residence time of the media in the reaction zone.

In any of the embodiments, the reaction zone can further comprise a filler, the characteristics of which enable variance in the reaction time.

In another exemplary embodiment, the present invention is a system comprising a mixture of at least two reagents and an inert filler, tuned for the effective removal of an unwanted species an aqueous solution, wherein a first reagent of the at least two reagents is a reactive reagent that will convert the unwanted species to an unwanted species anion by changing the pH of the unwanted species containing solution, and wherein a first reagent of the at least two reagents is an insoluble solid reagent that will bind to the unwanted species anion.

In any of the embodiments, the unwanted species can be boron, and the first reagent can be selected from the group consisting of brucite (Mg(OH)₂, magnesium oxide (MgO), and crushed concrete, a low solubility material that can affect the unwanted species containing solution pH, and a combination thereof.

In any of the embodiments, the unwanted species can be boron, and a second reagent of the at least two reagents can comprise an insoluble polymer containing positive charges.

In any of the embodiments, the second reagent can be selected from the group consisting of sawdust, paper fiber, compost, chitinous materials, and a combination thereof.

In any of the embodiments, the inert filler can be selected from the group consisting of sand, gravel, ground/crushed/pulverized glass, and chipped/ground plastics.

In any of the embodiments, the amounts of reagents and inert filler can be tuned to achieve application specific performance goals selected from the group consisting of removal efficiency, working life of the system before the reagents are expended, and hydraulic characteristics.

These and other aspects of the present disclosure are described in the Detailed Description below and the accompanying figures. Other aspects and features of embodiments of the present disclosure will become apparent to those of ordinary skill in the art upon reviewing the following description of specific, example embodiments of the present disclosure in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the disclosure discussed herein. In similar fashion, while example embodiments may be discussed below as device, system, or method embodiments, it is to be understood that such example embodiments can be implemented in various devices, systems, and methods of the present disclosure.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 is a graph of effluent boron concentration vs pore volumes passed through an exemplary embodiment of the present invention at influent concentration of 30 mg/l.

FIG. 2 is a schematic representation of an exemplary embodiments of the present invention as a system.

FIG. 3 is a table of technology performance comparisons between exemplary embodiments of the present invention and conventional remediation technologies for CQ1 and for K. Sasaki, H. Takamori, S. Moriyama, H. Yoshizaka, T. Hirajima, Effect Of Saw Dust On Borate Removal From Groundwater In Bench-Scale Simulation Of Permeable Reactive Barriers Including Magnesium Oxide, Journal of Hazardous Materials, Volume 185, Issues 2-3, 2011, Pages 1440-1447, ISSN 0304-3894; https://doi.org/10.1016/j.jthazmat.2010.10.067 for the other comparisons (CQ2 through CQ6 and the relative sustainability index estimate).

FIG. 4 is a star graph and attendant data related to the Relative Sustainability Index (RSI) of the technology performance comparisons, according to an exemplary embodiment of the present invention.

FIG. 5 is a graph of several conventional technologies and the present invention according to exemplary embodiments tested in a consistent manner, with boron concentrations upon a cycle of remediation.

FIGS. 6A-6B are tables of data relevant to the formation of the graph of FIG. 5.

### DETAILED DESCRIPTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or conducted in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

It should also be noted that, as used in the specification and the appended claims, the singular forms “a,” “an” and “the” include plural references unless the context clearly dictates otherwise. References to a composition containing “a” constituent is intended to include other constituents in addition to the one named.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” may be used herein to connote different aspects of methods employed, the term should not be interpreted as implying any particular order among or between various steps herein disclosed unless and except when the order of individual steps is explicitly required.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter. Additionally, the components described herein may apply to any other component within the disclosure. Merely discussing a feature or component in relation to one embodiment does not preclude the feature or component from being used or associated with another embodiment.

The present invention, as hereafter described, relates to the remediation of boron and/or molybdenum from ground water, but those of skill in the art will understand that other unwanted species, for example problematic anionic metals, contained in other types of aqueous media, can be remediated using the present technologies.

In reference to boron treatment, boron is a free acid at neutral pH and it is highly water soluble. Water containing boron is treated with the disclosed methods, and/or passed into a system configured to practice the methods, by one of several means.

A first reagent and a second reagent are mixed together in ratios suitable for the application. A filler may also be added to alter the hydraulic conductivity of the present invention.

Boron is converted to negatively charged borate (oxyanion) through a reagent (the first reagent) controlled pH reaction.

Borate is exposed to a solid phase material that is positively charged (the second reagent) that has been mixed with the first reagent. The negative and positive charges (borate and the solid phase material, respectively) attract and form ionic bonds which bind borate to the insoluble solid phase.

The pH of the treated effluent may be neutralized by exposure to the second reagent in the absence of the first reagent or in some cases by contact with natural geologic materials.

The end result of the action of the present invention is the effective removal of amounts of boron from water.

In exemplary embodiment of the present invention, it may take the form of an engineered permeable reactive barrier constructed in an aquifer with the first and second reagents along with an appropriate filler material to support flow through the reactive area. This represents a passive in situ treatment design.

In another exemplary embodiment of the present invention, it may take the form of a reactive mat constructed with the first and second reagents and filler at ground surface or slightly below so that contaminated groundwater seeps are treated by the invention when groundwater passes through the mat at the point where contaminated groundwater emerges from the ground to become surface water.

Alternatively, the blended reagents and filler may be placed in a container, basin, pond, engineered wetland, or tank with boron-contaminated water being pumped through the reagent mixture for the removal of boron from solution.

Exemplary first reagents include the mineral brucite that has the chemical formula of Mg(OH)₂ or magnesium oxide (MgO). It is available as powder up to small grain size.

An exemplary second reagent is sawdust-the cellulose, hemicellulose, and lignin structure provides many positive charges for binding borate in a fibrous, porous matrix with high surface area. Other complex, insoluble organic materials may be used for the second reagent, such as compost and chitin.

The filler is typically sand.

Performance testing has been conducted with a one part each of the first reagent, the second reagent, and sand (and with variations of these ratios). The binding capacity for boron is on the order of a few milligrams per gram of the reagent mixture.

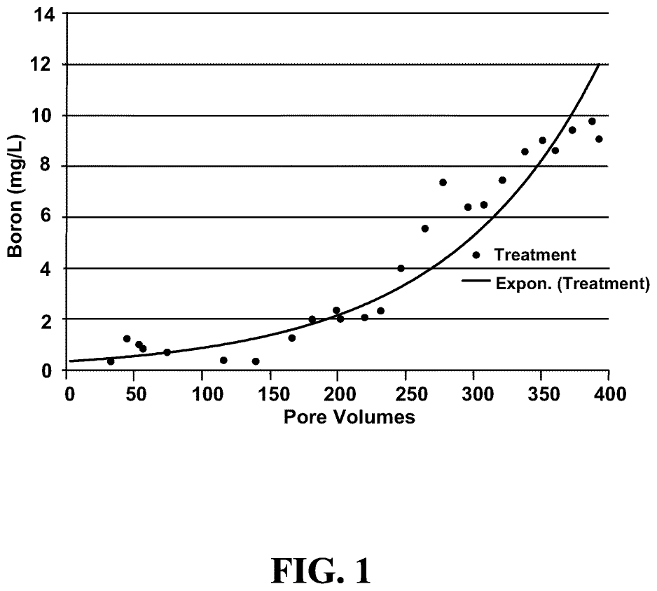

The effectiveness of the present invention for treating groundwater containing 30 mg/L boron is shown in FIG. 1. In an exemplary embodiment, a construction containing 30% of the first reagent, 30% of the second reagent, and 40% filler was demonstrated, with a six-hour hydraulic retention time. It was able to treat 180 pore volumes of groundwater contaminated with 30 mg/L of boron before break through occurred in excess of the Illinois state water quality standard of 2 mg/L boron.

As indicated in FIG. 1, additional treatment capacity remained such that further boron removal can be achieved for water quality standards greater than 2 mg/L. The ratio of reagents and the thickness of the reactive part of the present invention can be engineered to the site-specific groundwater seepage velocities and the influent boron concentration to provide several years of effective unattended treatment.

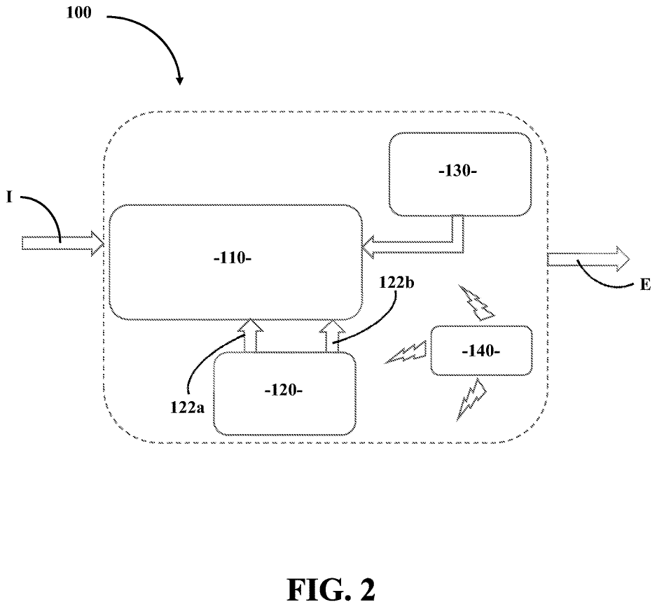

As shown in FIG. 2, the present invention 100 can comprise a reaction zone 110. Generally, the reaction zone 110 accepts the influent with containments, I, and releases the effluent E with a lower level, or free of, the containments. The relative positions of the subsystems/subassemblies is representative only.

The reaction zone 110 can comprise a part or wholly of an in situ construction or an ex situ construction. For example, an in situ reaction zone 110 can comprise a trench, an excavation, a large diameter borehole, a funnel and gate permeable reactive barrier system, a horizontal reactive mat constructed over groundwater seep areas, a constructed wetland, and/or other civil or environmental engineered system designed to retain the invention and allow contaminated water to pass through it.

An ex situ reaction zone 110 can comprise a tank, column, or other above ground structures designed to hold the reagents and allow water to flow through.

A reagent assembly 120 is designed to provide one or more reagents 122 to the influent I. In an exemplary embodiment, a first and second reagent 122a, 122b is present.

The reagent assembly 120 is installed in a way to contact the influent, for example, contaminated water such that the water can pass through the invention 100 to effect boron removal in the reaction zone 110.

Filler 130, preferably inert filler, can be co-located with the other components of the present invention.

The first reagent 122a can be a reactive reagent that will convert boron to borate anion by changing the pH of the influent containing boron. This first reagent can include brucite Mg(OH)₂ and/or magnesium oxide (MgO) and/or a similarly low solubility material such as crushed concrete that can affect solution pH.

The second reagent 122b can be an insoluble solid reagent that will bind borate and remove it from solution. The second reagent can be an insoluble polymer containing positive charges that may be cellulosic such as sawdust, paper fiber, and compost, or chitinous materials such as insect and crustacean shells.

Filler 130 can be sand, gravel, ground or crushed glass, or chipped/ground plastics that is essentially inert but controls hydraulic conductivity of the reagent mixture.

A control assembly 140 can control various aspects of the present invention, for example, where/when reagents and filler are mixed, and in what proportions, to achieve application-specific performance goals such as removal efficiency, working life of the system before the reagents are expended, and hydraulic characteristics. For example, the present invention can include monitoring the flow rate and/or pH of the influent, and/or the flow rate and/or pH of the effluent, and/or the amounts of reagents and/or filler with the control assembly 140, and dynamically changing downstream aspects of the method/system with the control assembly 140 in order to achieve superior results. As one of ordinary skill in the art will appreciate, the control assembly 140 can include an integrated system or disparate sub-systems, and a wide variety of processing and monitoring and memory and communication technologies in order to provide “smart” control/monitor of the process/system.

The present invention 100 can control the pH of the effluent from a reagent mixture of only the second reagent, or a different pH-modulating reagent, to neutralize the pH of effluent water.

The present invention is superior to any conventional remediation technology, at least as it relates to tested containments like boron.

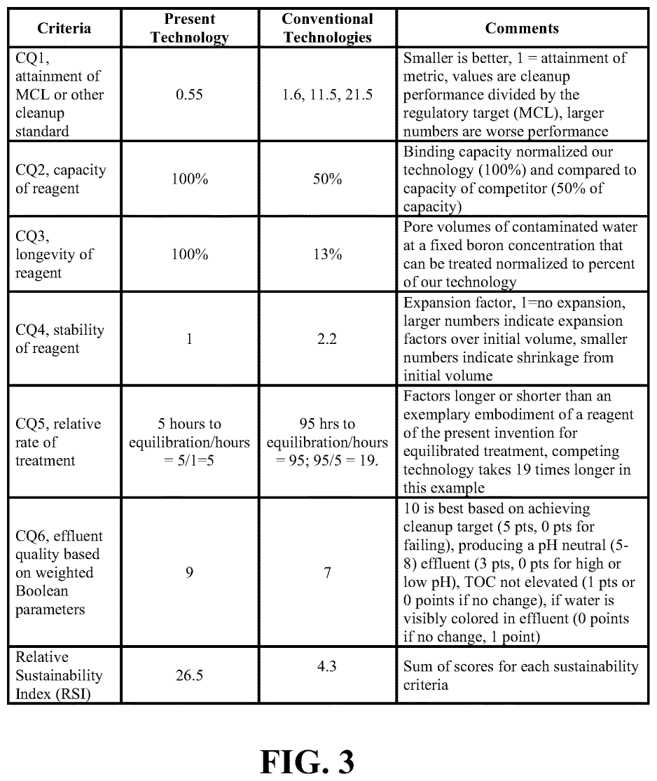

In one study, K. Sasaki et al. noted above in reference to FIG. 3, Mg(OH)₂ was used, but passivates MgO and limits boron removal.

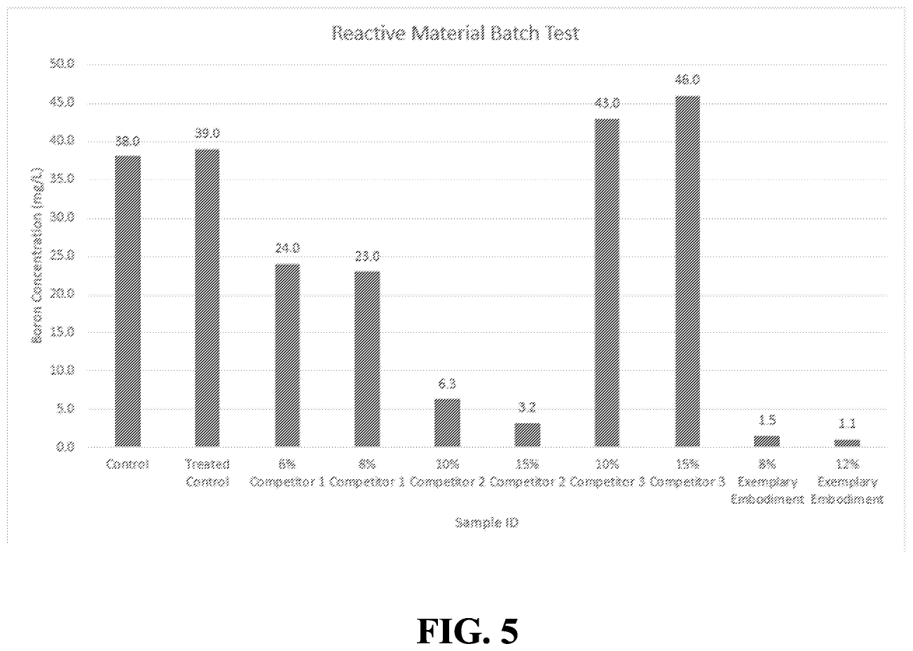

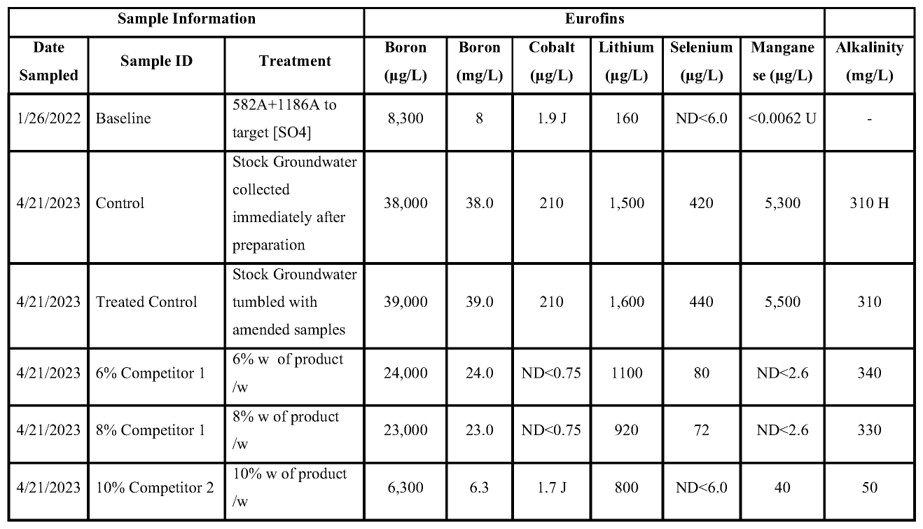

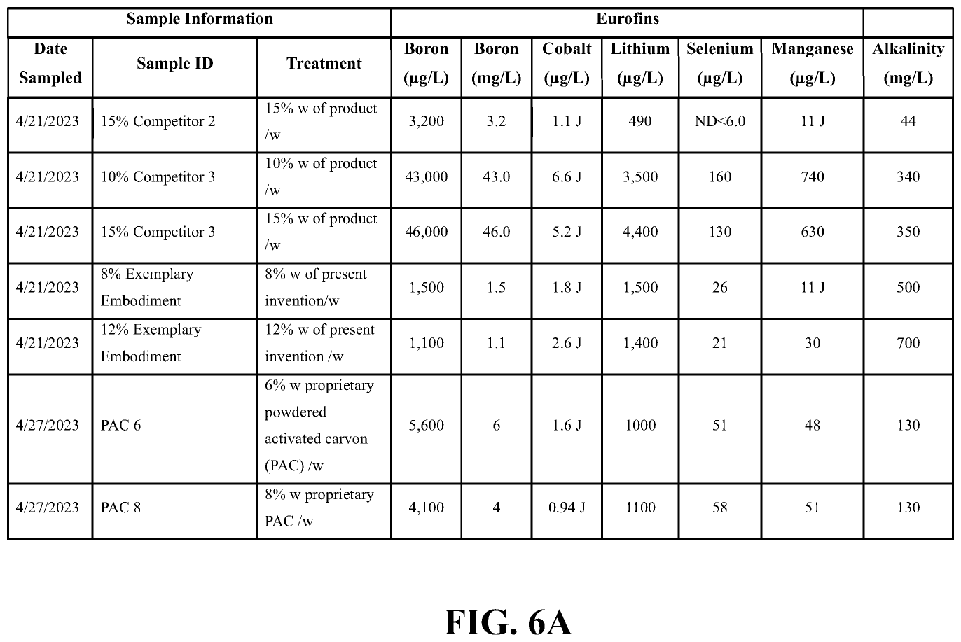

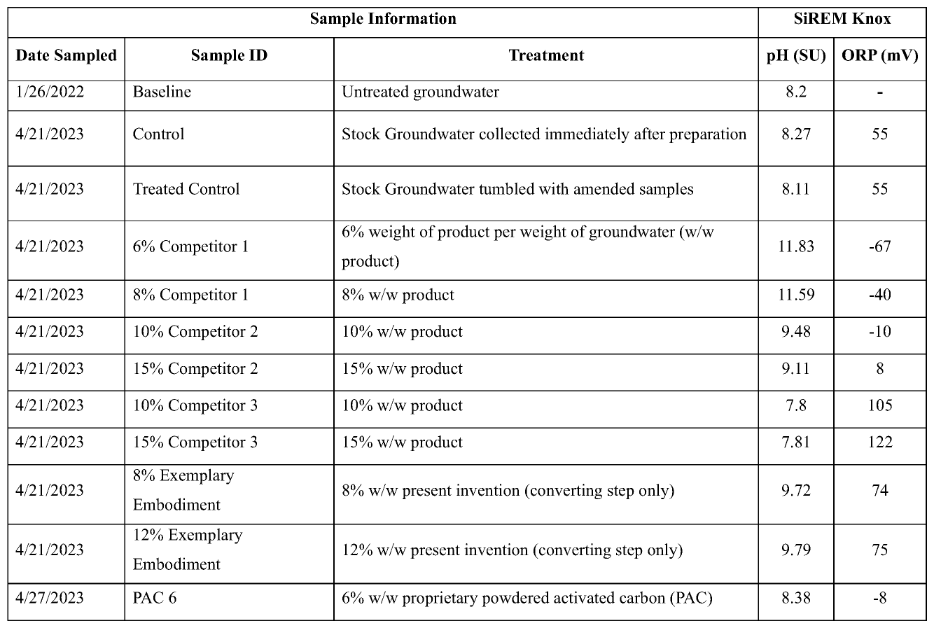

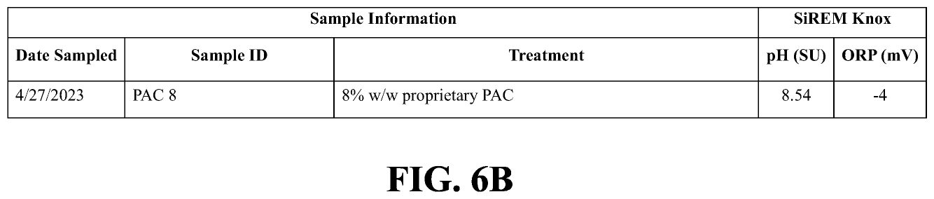

FIG. 5 illustrates results of a performance challenge (with the data shown in the Tables of FIGS. 6A-B). The ‘control’ bar is a solution used in testing immediately after mixing, and the ‘treated control’ is after that solution was tumbled for a duration of the experiment. A bar height illustrates the boron concentration of the effluent after testing, wherein the percentages represent the mass of each material of the Tables of FIGS. 6A-B added to a standard volume of water to measure removal efficiency.

Thus, it is apparent that a reaction efficiency (boron concentration prior to duration of each experiment over boron concentration after each experiment) of an exemplary embodiment of the present invention at 12% is 2.9% (1.1/38.0) (the uninhibited amount remaining in solution after reaction). Against any competitive method tested, the next best reaction efficiency with a higher reactive amount of materials (15%) is only 8.4% (3.2/38.0) (the uninhibited amount remaining in solution after reaction).

The present invention can deliver a nearly 300% improvement in reaction efficiency with a lower amount of reactive materials.

While specific to Sasaki et al., the present invention embodies numerous advantages over conventional systems, including that it has a stable volume (no swelling), no pre-treatments of reagents or influent water, shorter retention time for comparable treatment efficiency, greater binding capacity (two times more boron bound per gram of reaction medium), a longer life by at least 7.5 times, an effluent pH near neutral, and a lower carbon footprint and overall greater sustainability.

In an exemplary embodiment of the present invention, Mg(OH)₂ is used as well, but it achieves greater mass removal for more pore volumes (200 vs about 20 PVs for Sasaki et al. and greater removal capacity 1 to 2 mg/g vs 0.48 to 0.76 mg/g for Sasaki et al.).

As those of skill in the art appreciate, MgO will naturally convert to Mg(OH)₂ in water and increase in volume by 2.2 times per Sasaki et al. This has serious consequences for in situ and ex situ engineered remediation systems that leads to plugging, swelling, and loss of performance.

MgO systems saturate or begin to fail in about 24 pore volumes, in patentable and effective contrast to the present Mg(OH)₂ system that lasts for 180 to 200 PVs.

Sawdust has low sorption capacity per Sasaki et al. Yet, the present invention illustrates just the opposite.

Sasaki et al. teaches pre-treatment by pH adjustment with NaOH and purification/washing of sawdust, steps completely missing from the present invention. They are not required.

Sasaki et al. is left with a high pH effluent. Beneficially, the present inventive process naturally neutralizes the effluent which eliminates a step that would be required in Sasaki et al.'s system.

Sawdust increases performance by 1.6 times for Sasaki et al.. Sawdust or a similar material is preferably used in the present process with its use providing an overall performance improvement yielding greater capacity (50 to 100% more boron adsorbed) and longer life by at least 7.5 times.

The removal of boron from water is similar. Sasaki et al. teaches removal of boron to below the TTL, but it is silent on which TTL is used. The present technology removes boron to 1.1 to 1.5 mg/L when starting with comparable-to-Sasaki et al. initial boron concentration in water to be treated.

Sasaki et al.'s system requires relatively long retention times of 95 hours or more. The present invention achieved comparable, if not superior, treatment in approximately 5 to 6 hours.

MgO requires more energy input for manufacturing than Mg(OH)₂, thus the present invention need not include water pre-treatment as discussed above, and sawdust is renewable; therefore, the present technology is more sustainable than Sasaki et al.'s.

### EXAMPLES

At present, a dearth of effective treatment technologies that can serve as comparators to the present technology makes quantification of performance challenging. Nonetheless, compiled and anonymized data from alternate technologies follows, where the data are normalized against the performance to exemplary embodiments of the present invention.

While the examples are specific to boron treatment, as discussed above the present invention is effective over other unwanted species.

The performance of the present remediation technology can be evaluated against at least seven criteria: (Note in cases were an alternate technology is not specified in the criteria for comparison to the present technology, the present technology applied under site specific conditions may be substituted to evaluate performance as it may be affected by site conditions relative to standardized conditions, especially when exchanging deionized water in the standardized condition for naturally occurring groundwater in the site specific condition.)
Achievement of clean-up goals;
Capacity;
Longevity;
Physical stability;
Rate of treatment;
Effluent quality; and
Sustainability.

### Comparative Quantity 1, Attainment of TTL or Other Clean-Up Standards:

CQ1=[c]/[S] (1)
where:
CQ1 is the Comparative Quantity 1;
[c] is the concentration achieved by the present invention in typical units of mass/volume, such as milligram per liter (mg/L); and
[S] is the concentration of a treatment standard in the same units as [c].

CQ1 can be derived from FIGS. 5 and 6.

### Comparative Quantity 2, Capacity of Reagent:

CQ2=L/L′*100 (2)
where:
CQ2 is the Comparative Quantity 2 as a percent of the present invention's reagent performance;
L is the loading capacity as mg of boron per gram of a conventional reagent; and
L′ is the loading capacity of a reagent of the present invention measured in a standard unit, such as mg/g.)

### Comparative Quantity 3, Longevity of Reagent:

CQ3=P/P′*100 (3)
where:
CQ3 is the Comparative Quantity 3 as a percent of present reagent performance;
P is the pore volumes of boron solution at a known concentration needed for breakthrough (saturation of a conventional adsorbent reagent); and
P′ is the pore volumes for boron breakthrough of a reagent of the present invention at the same solution concentration as for P.

### Comparative Quantity 4, Stability of Reagent:

CQ4=S/S′ (4)
where:
CQ4 is the Comparative Quantity 3 as relative volume expansion compared to the present reagent which does not expand;
S is the expansion factor for a conventional reagent; and
S′ is the expansion of a reagent of the present invention (typically 1).

### Comparative Quantity 5, Relative Rate of Treatment:

CQ5=(T′*n/T*n) (5)
wherein:
CQ5 is the Comparative Quantity 5 as treatment time relative to the present reagent;
T is the reagent contact time of the present invention needed to achieve a treatment standard (time units may be any standard unit that must be constant for the present reagent and other technology in the comparison, hours is most common, but minutes, days, or other time units may be used);

T′ is the contact time needed for conventional technologies to achieve the same treatment standard in same units of time as T; and
n is a standard unit of time, such as a fixed number of time units (1 hour is typical).

### Comparative Quantity 6, Effluent Quality Based on Weighted Boolean Parameters:

CQ6=TTL+pH+TOC+Color (6)
where:
TTL is 5 points if treatment standard is attained, 0 points if not;
pH is 3 points if pH of effluent is between 5 and 9, 0 points if not;
TOC is 1 point if TOC of effluent is not elevated more than 25% over influent, 0 points of TOC is more than 25% over influent TOC; and
Color is 1 point if the effluent has the same color than influent as visually assessed in a 1 liter clear glass bottle, 0 if a perceptible color change is detected in the effluent.

Scores may range from 0 to 10.

### Relative Sustainability Index (RSI)

Sustainability factors:
Energy Input is 0 to −10 relative scale, where 0 is energy neutral;
Material use, 0 to 10, relative assessment of the amount of reagent needed for treatment;
End of life, length of function life, (useful life of the present technology/useful life of conventional technologies);
Reagent Cost as $100s per ton;
Protection of environment, 0 to 10 relative scale; and
Value, 0 to 10 relative scale based on relative cost savings, cost avoidance, etc.

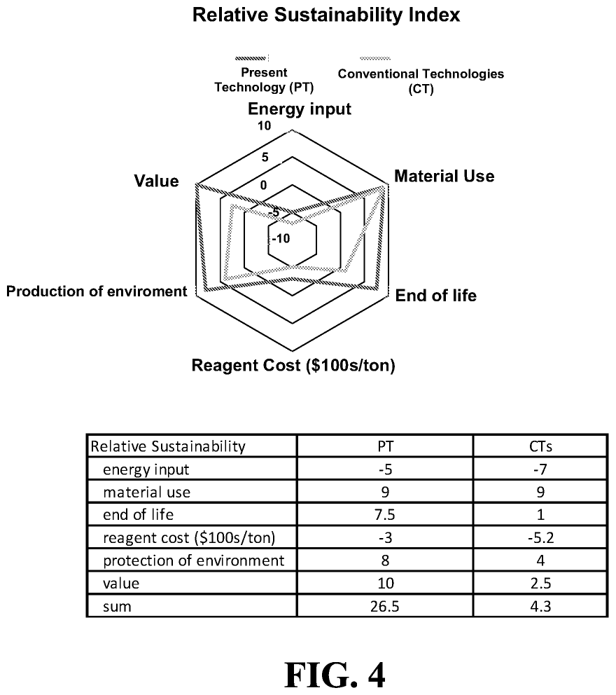

RSI, may be conveyed as the sum of factors or as a star graph (FIG. 4)

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and conducted in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for conducting the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

1. A method comprising:
converting a nonionized form of an unwanted species in an influent of media having an initial concentration of the unwanted species to an anionic form of the unwanted species; and
exposing the anionic form of the unwanted species to a cationic form of a removal agent;
wherein an effluent of the media has a treated concentration of the unwanted species less than the initial concentration.

2. The method of claim 1 further comprising:
inhibiting at least a portion of the unwanted species, which is ionically bonded to the removal agent, from the effluent;
wherein:
the method is an in situ process of remediation of the influent;
the converting, exposing and inhibiting occur in a reaction zone; and
a reaction efficiency of initial concentration/treated concentration is less than 8.4% of the influent concentration passes through uninhibited to the effluent.

3. The method of claim 1, wherein:
the initial concentration of the unwanted species exceeds a treatment target level (TTL); and
the removal agent is cellulosic material.

4. The method of claim 2, wherein:
the initial concentration of the unwanted species exceeds a treatment target level (TTL); and
the treated concentration of the unwanted species is less than the TTL.

5. The method of claim 4, wherein the reaction zone is at least a portion of a construction selected from the group consisting of a trench, an excavation, a large diameter borehole, a funnel and gate permeable reactive barrier system, a horizontal reactive mat constructed over groundwater seep areas, a constructed wetland, other civil or environmental engineered systems designed to retain the reaction zone and allow the influent to pass therethrough, and a combination thereof.

6. The method of claim 1 further comprising:
inhibiting at least a portion of the unwanted species, which is ionically bonded to the removal agent, from the effluent;
wherein:
the method is an ex situ process of remediation of the influent;
the converting, exposing and inhibiting occur in a reaction zone;
a reaction efficiency of initial concentration/treated concentration is less than 8.4% of the influent concentration passes through uninhibited to the effluent; and
the reaction zone is at least a portion of a construction selected from the group consisting of a tank, a column, other above ground structures designed to retain the reaction zone and allow the influent to pass therethrough, and a combination thereof.

7. The method of claim 2, wherein at least one of:
the converting comprises mixing a first amount of a first reagent with the influent;
the exposing comprises mixing a second amount of the removal agent;
the nonionized form of the unwanted species is converted to the anionic form of the unwanted species through a reagent-controlled pH reaction with the first reagent;
at least a portion of the converting is concurrent with at least a portion of the exposing;
the exposing is fully subsequent to the converting;
the unwanted species is at least partially soluble in the media; or the removal agent is at least partially insoluble in the media.

8. The method of claim 6, wherein at least one of:
the converting comprises mixing a first amount of a first reagent with the influent;
the exposing comprises mixing a second amount of the removal agent;
the nonionized form of the unwanted species is converted to the anionic form of the unwanted species through a reagent-controlled pH reaction with the first reagent;
at least a portion of the converting is concurrent with at least a portion of the exposing;
the exposing is fully subsequent to the converting;
the unwanted species is at least partially soluble in the media; or
the removal agent is at least partially insoluble in the media.

9.-13. (canceled)

14. The method of claim 2, wherein:
the unwanted species is boron;
the media is water; and
the removal agent comprises organic material.

15. The method of claim 6, wherein:
the unwanted species is boron;
the media is water; and
the removal agent is cellulosic material.

16.-20. (canceled)

21. The method of claim 1 further comprising:
inhibiting at least a portion of the unwanted species, which is ionically bonded to the removal agent, from the effluent;
wherein:
the unwanted species is a contaminate;
the influent is a contaminated influent; and
the media is water.

22.-29. (canceled)

30. The method of claim 21, wherein:
the contaminate is boron;
the removal agent comprises organic material;
the converting comprises mixing a first amount of a first reagent with the boron-contaminated influent; and
boron is converted to borate through a reagent-controlled pH reaction with the first reagent, raising a circumneutral or acidic pH of the influent to an alkaline pH of approximately 9.2 and higher.

31. The method of claim 21, wherein:
the removal agent comprises organic material;
the method is configured for both in situ and ex situ processing of the contaminated influent; and either
the converting, exposing and inhibiting occur in a reaction zone at substantially the same time; or
the converting, exposing and inhibiting each occur in a reaction zone at discretely different times.

32.-33. (canceled)

34. The method of claim 1 further comprising:
effectively removing at least a portion of the unwanted species, which is ionically bonded to the removal agent, from the effluent;
wherein the method has at least one of:
an attainment standard (CQ1) of less than 1.6;
a capacity of reagent (CQ2) of greater than 50%;
a longevity of reagent (CQ3) of greater than 13%;
a stability of reagent (CQ4) of less than 2.2;
a relative rate of treatment (CQ5) of less than 19;
an effluent quality based on weighted Boolean parameters (CQ6) of greater than 6; or
a relative sustainability index (RSI) of over 4.3.

35. The method of claim 1 further comprising:
effectively removing at least a portion of the unwanted species, which is ionically bonded to the removal agent, from the effluent;
wherein the method has;
an attainment standard (CQ1) of less than 1.6;
a capacity of reagent (CQ2) of greater than 50%;
a longevity of reagent (CQ3) of greater than 13%;
a stability of reagent (CQ4) of less than 2.2;
a relative rate of treatment (CQ5) of less than 19;
an effluent quality based on weighted Boolean parameters (CQ6) of greater than 6; and
a relative sustainability index (RSI) of over 4.3.

36.-42. (canceled)

43. The method of claim 1 further comprising:
inhibiting at least a portion of the unwanted species, which is ionically bonded to the removal agent, from an effluent of the media;
whereing
the converting, exposing and inhibiting occur in a reaction zone over a reaction time;
the reaction zone comprises filler material; and
a reaction efficiency of initial concentration/treated concentration is less than 8.4% when:
the influent comprises water at an influent pore volumes and the unwanted species is boron;
the converting comprises mixing the influent with a first reagent selected from the group consisting of brucite (Mg(OH)₂, magnesium oxide (MgO), and crushed concrete to form borate; and
the exposing comprises mixing the influent comprising borate with the removal agent comprising organic material.

44. The method of claim 1, wherein:
the converting comprises first exposing the nonionized form of the unwanted species to a first amount of a first reagent; and
the exposing the anionic form of the unwanted species comprises second exposing at least a portion of the anionic form of the unwanted species to the cationic form of the removal agent being a second amount of a second reagent;
wherein after the second exposing, the effluent has the treated concentration of the unwanted species less than the initial concentration.

45. The method of claim 44, wherein:
the influent is an influent of groundwater;
the unwanted species is boron;
the first reagent is selected from the group consisting of brucite (Mg(OH)₂, magnesium oxide (MgO) and crushed concrete; and
the second reagent comprises organic material.

46. The method of claim 44, wherein:
the influent is an influent of groundwater; and
the unwanted species is molybdenum.

47. (canceled)

48. The method of claim 44 further comprising:
inhibiting at least a portion of the unwanted species, which is ionically bonded to the second reagent, from the effluent;
wherein the inhibiting comprises separating at least a portion of the unwanted species, which is ionically bonded to the second reagent, from the media by a separating action selected from the group consisting of filtering, fluidization, flotation, settling, coagulation/flocculation, and a combination thereof.

49. The method of claim 48, wherein:
the first exposing and the second exposing occur over a reaction time in a reaction zone; and
the inhibiting is controllable with variance in the reaction time.

50. The method of claim 49, wherein:
the reaction zone comprises filler; and
variance in the reaction time is at least partially due to the filler.

51. The method of claim 49, wherein:
the reaction zone comprises filler; and
variance in the reaction time is at least partially due to characteristics of the filler selected from the group consisting of filler chemistry, filler particle size, filler density, and a combination thereof.

52. The method of claim 48, wherein at least one of:
the first exposing comprises converting the nonionized form of the unwanted species to the anionic form of the unwanted species through a reagent-controlled pH reaction with the first reagent;
at least a portion of the first exposing is concurrent with at least a portion of the second exposing:
the second exposing is fully subsequent the first exposing;
the unwanted species is soluble in the media;
the unwanted species is boron;
the second reagent is insoluble in the media;
the second reagent comprises organic material;
the second reagent is cellulosic material;
the second reagent is sawdust;
the initial concentration of the unwanted species exceeds a TTL;
the treated concentration of the unwanted species is less than the TTL; or
the media comprises water.

53-63. (canceled)

64. The method of claim 50, wherein the filler is an inert, solid, nonporous medium.

65. (canceled)

66. A method comprising:
passing an influent of media having an initial concentration of unwanted species exceeding a TTL through a reaction zone comprising a first reagent and a second reagent;
wherein after the reaction zone, an effluent of the media has a treated concentration of the unwanted species less than the TTL.

67. The method of claim 66 further comprising:
controlling a residence time of the media in the reaction zone.

68. The method of claim 67, wherein the reaction zone further comprises a filler, the characteristics of which enable variance in the reaction time.

69. A system comprising:
a mixture of at least two reagents and an inert filler, tuned for the effective removal of an unwanted species an aqueous solution;
wherein a first reagent of the at least two reagents is a reactive reagent that will convert the unwanted species to an unwanted species anion by raising the pH of the unwanted species containing solution to an alkaline pH of approximately at least 9.2; and
wherein a first reagent of the at least two reagents is an insoluble solid reagent that will bind to the unwanted species anion.

70. The system of claim 69, wherein at least one of:
the unwanted species is boron and the first reagent is selected from the group consisting of brucite (Mg(OH)₂, magnesium oxide (MgO) and crushed concrete, a low solubility material that can affect the unwanted species containing solution pH, and a combination thereof;
the unwanted species is boron and a second reagent of the at least two reagents comprises an insoluble polymer containing positive charges;
a second reagent of the at least two reagents is selected from the group consisting of sawdust, paper fiber, compost, chitinous material, and a combination thereof;
the inert filler is selected from the group consisting of sand, gravel, ground/crushed glass and chipped/ground plastics; or
the amounts of reagents and inert filler are tuned to achieve application specific performance goals selected from the group consisting of removal efficiency, working life of the system before the reagents are expended, and hydraulic characteristics.

71.-74. (canceled)
